(19) United States
(12) Patent Application Publication
(10) Pub. No.: US 2005/0031303 A1
(43) Pub. Date: Feb. 10, 2005

(54) Method for managing bookmark information and method for reproducing content using the same

(76) Inventor: Gwang Sik Park, Suwon-si (KR)

Correspondence Address: BIRCH STEWART KOLASCH & BIRCH, PO BOX 747, FALLS CHURCH, VA, 22040-0747, US

(21) Appl. No.: 10/840,302

(22) Filed: May 7, 2004

(30) Foreign Application Priority Data
May 10, 2003 (KR) 10-2003-0029584

(51) Int. Cl. H04N 5/783

(52) U.S. Cl. 386/69; 386/70

(57) ABSTRACT

The present invention relates to a method for managing bookmark information and a method for reproducing content using the same. An optical disc device such as a DVD (Digital Versatile Disc) player stores start and end addresses of a predetermined region of a recording medium as bookmark information and also stores the bookmark information in linkage to identification information indicating an interval bookmark for region playback. Therefore, a user can conveniently reproduce a predetermined region of a desired recording medium.

### BACKGROUND OF THE INVENTION

1. Field of the Invention

The present invention relates to a method for managing bookmark information and a method for reproducing content using the same, and more particularly to a method for managing bookmark information indicating a predetermined region of a recording medium and reproducing content using the bookmark information.

2. Description of the Related Art

Recently, an optical disc device such as a DVD (Digital Versatile Disc) player capable of permanently recording or reproducing high-quality video and audio data has been commercialized. As shown in FIG. 1, the optical disc device includes an optical pickup 11, a VDP (Video Disc Player) system 12, a microcomputer 13, a memory 14 and an OSD (On Screen Display) generator 15.

The microcomputer 13 controls the VDP system 12 according to a request from a user, such that a playback operation is carried out for data recorded on an optical disc 10. Moreover, the microcomputer 13 stores a specific location of an image selected by the user as bookmark information in the memory 14 while the playback operation is carried out. The user can easily reproduce the image of the specific location using a bookmark.

On the other hand, when the user makes a bookmark list display request, the microcomputer 13 controls an operation of the OSD generator 15, such that the OSD generator 15 can generate an OSD image about bookmark information read from the memory 14 and then output the generated OSD image to an external display unit such as a television.

While the optical disc 10 is reproduced, a location of an image that the user desires to view again later can be set as a bookmark. Subsequently, when the optical disc 10 is reproduced again, the user can select a desired bookmark from a preset bookmark list displayed in the OSD image so that a location of the selected bookmark can be easily retrieved from the optical disc 10 and content identified by the location of the selected bookmark can be reproduced.

In addition to a basic bookmark function necessary for easily and quickly reproducing content linked to a desired location, the user can make a request so that a location of a specific region of the optical disc 10 to be reproduced, for example, a location of a music video linked to a title, etc., is set as a bookmark.

However, because only an address of the specific location selected by the user is managed in the conventional optical disc device, the user must specially manipulate a key to reproduce a predetermined region of the optical disc. Thus, the user may encounter inconvenience.

### SUMMARY OF THE INVENTION

Therefore, the present invention has been made in view of the above problems, and it is one object of the present invention to provide a method that can manage a predetermined region that a user desires to reproduce as bookmark information.

It is another object of the present invention to provide a method that can store start and end points of a predetermined region that a user desires to reproduce as bookmark information.

It is another object of the present invention to provide a method that can manage interval bookmark information for region playback as well as general bookmark information of every disc.

It is yet another object of the present-invention to provide a method that can display interval bookmark information for region playback in an OSD (On Screen Display) image and can allow a user to select a bookmark from the displayed bookmark information so that content of a desired region linked to the selected bookmark can be reproduced.

In accordance with an aspect of the present invention, the above and other objects can be accomplished by the provision of a method for managing bookmark information, comprising: managing a start address and an end address for reproducing a region of a recording medium as the bookmark information.

In accordance with another aspect of the present invention, there is provided a method for managing bookmark information, comprising the steps of: (a) when a bookmark is selected while a user reproduces content, displaying a menu screen so that a general bookmark and an interval bookmark for region playback can be selected; (b) when the interval bookmark for the region playback is selected, temporarily storing a location of the selected bookmark as a start address; and (c) when the user re-selects a bookmark, setting a location of the re-selected bookmark as an end address, and storing the bookmark information including the temporarily stored start address and the end address.

In accordance with another aspect of the present invention, there is provided a method for reproducing content, comprising the steps of: (a) sequentially displaying stored bookmarks according to start addresses included in bookmark information so that a user can select a bookmark of a recording medium to be reproduced; and (b) when an interval bookmark for region playback is selected, carrying out a playback operation for content between a start address and an end address included in selected bookmark information.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a block diagram illustrating a conventional optical disc device;

FIG. 2 shows bookmark information and address information in accordance with the present invention;

FIG. 3 is a table illustrating bookmark information managed by a bookmark information management method in accordance with the present invention; and

FIG. 4 shows an OSD (On Screen Display) image displayed through the bookmark information management method in accordance with the present invention.

### DETAILED DESCRIPTION OF PREFFERRED EMBODIMENTS

Hereinafter, a method for managing bookmark information and a method for reproducing content using the same in accordance with preferred embodiments of the present invention will be described in detail with reference to the annexed drawings.

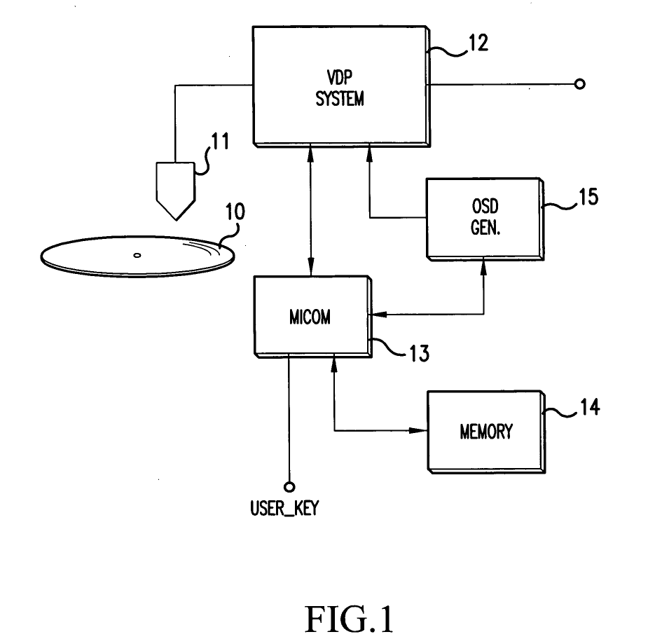

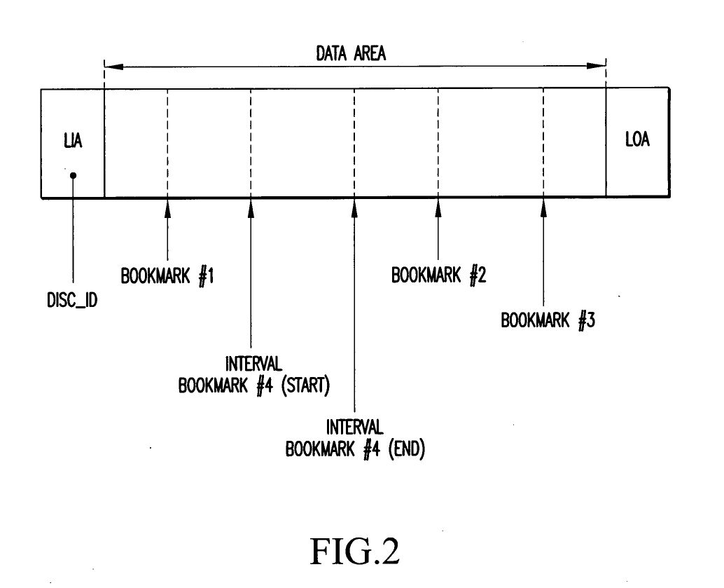

The method for managing bookmark information and the method for reproducing content using the same in accordance with the present invention can be applied to an optical disc device constituted as shown in FIG. 1. As shown in FIG. 2, the microcomputer 13 provided in the optical disc device manages addresses of specific locations selected by a user as general bookmark information (indicated by Bookmarks #1, #2 and #3). Moreover, start and end addresses of a predetermined region of the optical disc that the user desires to reproduce are managed as interval bookmark information for a specific region playback in the memory 14.

The bookmark information can be recorded in linkage to identification information, that is, a flag necessary for discriminating the general bookmark information or the interval bookmark information for the specific region playback, for example, “BM (Bookmark)_Type_Flag”. If “BM_Type_Flag” is “0”, the flag value “0” indicates general bookmark information in which only a start address is recorded. Otherwise, if “BM_Type_Flag” is “1”, the flag value “1” indicates interval bookmark information for the specific region playback in which start and end addresses of a predetermined region are recorded.

While image data is reproduced, the user presses a bookmark button provided in a remote controller to select a bookmark so that the user can again view content of a desired location. At this point, the microcomputer 13 controls the operation of the OSD generator 15 so that the OSD generator 15 displays an OSD image for allowing the user to select a general bookmark or an interval bookmark. If the user has selected the general bookmark, the general bookmark having a start address indicating an image data address of a current bookmark is stored in the memory 14 without an end address.

Otherwise, if the user has selected the interval bookmark, the start address indicating the image data address of the current bookmark is temporarily stored. Subsequently, where the user selects a new bookmark, an image data address corresponding to the newly selected bookmark is set as an end address. In this case, the end address can be stored in the memory 14 together with the temporarily stored start address as the interval bookmark. Moreover, “BM_Type_Flag” is set to “1” so that a bookmark type is an interval bookmark. Where no bookmark associated with the end address is selected in a state in which the start address is temporarily stored, the start address is stored as a general bookmark rather than an interval bookmark. Where the user designates a new bookmark in a state in which the start address of the interval bookmark is temporarily stored, the user can be asked as to whether the address of the new bookmark will be set to a general bookmark or an end address of the interval bookmark, such that the user can select the general bookmark or the interval bookmark.

Where an interval bookmark button is provided in a remote controller, etc., a start address is temporarily stored when the interval bookmark button is first pressed, and an end address can be stored in the memory 14 as an interval bookmark together with the temporarily stored start address when the interval bookmark button is pressed a second time.

Now, a method for reproducing an optical disc using a plurality of bookmark information units stored in the memory 14 will be described.

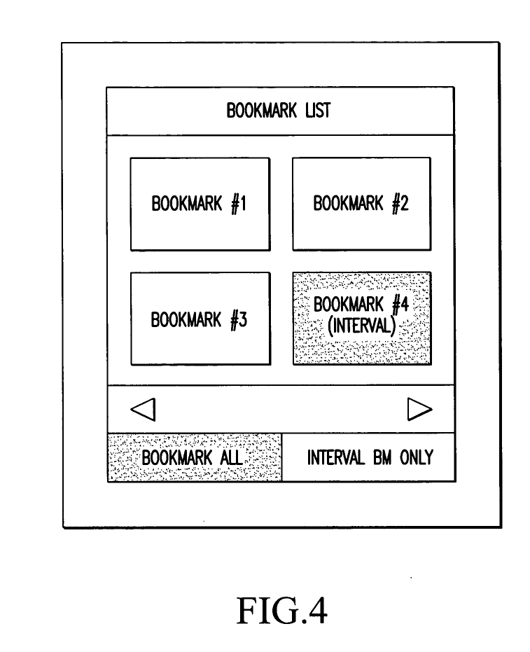

The microcomputer 13 controls an operation of the OSD generator 15 in response to a user request, and displays an OSD image of a bookmark list on an external display unit such as a television as shown in FIG. 4.

Where the user makes a request for displaying all bookmarks, the microcomputer 13 enables all bookmark information units managed in the memory 14 to be retrieved and displayed. If the user makes a request for selectively displaying only interval bookmark information for a specific region playback, only bookmark information units whose flag values “BM_Type_Flag” are set to “1” are selectively read and displayed.

When a general bookmark is selected from the bookmark list, the microcomputer 13 retrieves a start address of the selected general bookmark and carries out a playback operation at the optical disc's location corresponding to the retrieved start address.

On the other hand, the user selects an interval bookmark for a specific region playback, the microcomputer 13 retrieves start and end addresses of the selected interval bookmark and reproduces a specific region of the optical disc linked to the retrieved addresses. The specific region of the optical disc can be set to be repeatedly reproduced the predetermined number of times according to the user's selection.

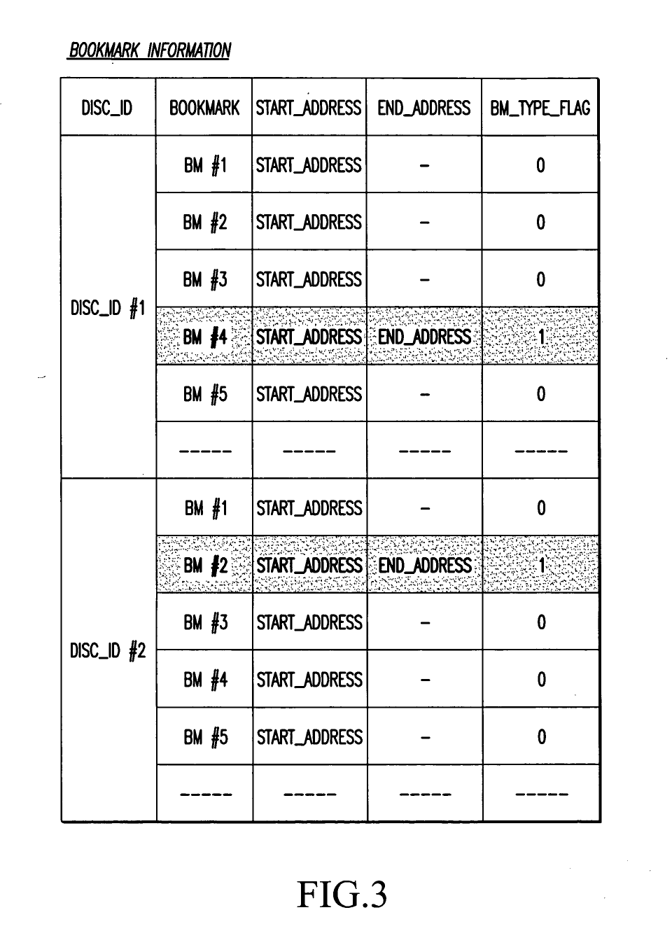

Moreover, the microcomputer 13 can store the bookmark information in linkage to disc ID information recorded on a lead-in area of the optical disc as shown in FIG. 3. This is to implement a bookmark function for a plurality of discs. When the microcomputer 13 creates a bookmark, it can store the created bookmark in linkage to a disc ID for discriminating one disc from another. Subsequently, when the disc is inserted, the microcomputer 13 reads bookmark information linked to the disc ID information.

The above description has been given of the bookmark information stored in the memory of the optical disc device. However, in order that the bookmark information can be used when any optical disc device reproduces a recordable optical disc, it is preferred that a recorder records the bookmark information on the recordable optical disc.

Typically, where the recorder records a plurality of programs, it is preferred that a program ID is stored in linkage to a bookmark so that only bookmark information associated with a corresponding program can be selectively viewed.

The bookmark information records identification information indicating a bookmark type, but a type of bookmark information can be discriminated using the presence of an end address without using the identification information.

As apparent from the above description, the present invention can store a location of a region to be reproduced as a bookmark.

Furthermore, the present invention can separately store a general bookmark and an interval bookmark for region playback, thereby selecting and reproducing a bookmark desired by a user.

Furthermore, the present invention can classify and store bookmarks in a plurality of optical discs, thereby employing a bookmark function in the plurality of optical discs.

Furthermore, the present invention can record bookmark information on a recordable optical disc, thereby employing bookmark information in any optical disc device.

Although the preferred embodiments of the present invention have been disclosed for illustrative purposes, those skilled in the art will appreciate that various modifications, additions and substitutions are possible, without departing from the scope of the invention.

1. A method for managing bookmark information, comprising:
managing a start address and an end address for reproducing a region of a recording medium as the bookmark information.

2. The method of claim 1, wherein the bookmark information is managed in linkage to identification information indicating an interval bookmark for region playback.

3. The method of claim 1, wherein the bookmark information is stored within a device for reproducing the recording medium.

4. The method of claim 3, wherein the bookmark information is managed in linkage to unique ID (Identification) information of the recording medium.

5. The method of claim 1, wherein the bookmark information is recorded on the recording medium.

6. The method of claim 1, wherein an ID (Identification) of a program belonging to a region indicated by a bookmark is managed in linkage to the bookmark.

7. A method for managing bookmark information, comprising the steps of:
(a) when a bookmark is selected while a user reproduces content, displaying a menu screen so that a general bookmark and an interval bookmark for region playback can be selected;
(b) when the interval bookmark for the region playback is selected, temporarily storing a location of the selected bookmark as a start address; and
(c) when the user re-selects a bookmark, setting a location of the re-selected bookmark as an end address, and storing the bookmark information including the temporarily stored start address and the end address.

8. The method of claim 7, wherein the step (c) comprises the steps of:
(c-1) re-displaying the menu screen so that the general bookmark or the interval bookmark for the region playback can be selected in a state where the start address is temporarily stored; and
(c-2) storing the bookmark information including an address of the re-selected bookmark when the general bookmark is selected, and setting the location of the re-selected bookmark as the end address to store the bookmark information including the temporarily stored start address and the end address when the interval bookmark for the region playback is selected.

9. The method of claim 7, further comprising the step of:
if the user terminates a playback operation without re-selecting a bookmark in a state where the start address is temporarily stored, storing the bookmark information including only the temporarily stored start address.

10. The method of claim 7, further comprising the step of:
storing identification information indicating that the stored bookmark information is the interval bookmark for the region playback in linkage to the bookmark information.

11. The method of claim 7, wherein the bookmark information is stored within a device for reproducing the recording medium.

12. The method of claim 11, wherein the bookmark information is stored in linkage to unique ID (Identification) information of the recording medium.

13. The method of claim 7, wherein the bookmark information is recorded on a recording medium.

14. The method of claim 7, wherein an ID (Identification) of a program belonging to a region indicated by a bookmark is stored in linkage to the bookmark.

15. A method for reproducing content, comprising the steps of:
(a) sequentially displaying stored bookmarks according to start addresses included in bookmark information so that a user can select a bookmark of a recording medium to be reproduced; and
(b) when an interval bookmark for region playback is selected, carrying out a playback operation for content between a start address and an end address included in selected bookmark information.

16. The method of claim 15, wherein the bookmark is discriminated and displayed as a general bookmark or an interval bookmark for region playback.

17. The method of claim 16, wherein the interval bookmark for the region playback is discriminated according to the presence of identification information for discriminating the interval bookmark from the general bookmark stored in linkage to the interval bookmark.

18. The method of claim 16, wherein the bookmark information for the region playback is discriminated according to the presence of an additionally recorded end address.

19. The method of claim 15, wherein the bookmark information is stored in linkage to unique ID (Identification) information of the recording medium within a device for reproducing the recording medium.

20. The method of claim 19, wherein the step (a) is carried out by retrieving bookmark information stored in linkage to an ID of the recording medium in the bookmark information stored in the device, and sequentially displaying retrieved bookmarks according to start addresses included in the bookmark information.

21. The method of claim 15, wherein the bookmark information is recorded on the recording medium.

22. The method of claim 15, wherein each of the bookmarks is displayed together with an ID (Identification) of a program belonging to a region indicated by a bookmark.
